(19) United States
(12) Patent Application Publication
(10) Pub. No.: US 2024/0025068 A1
(43) Pub. Date: Jan. 25, 2024

(54) SELF-USE BODY-CARE DEVICE WITH INTERCHANGEABLE HEADS

(71) Applicant: Jon Paul DUVALL, Milton, GA (US)

(72) Inventor: Jon Paul DUVALL, Milton, GA (US)

(21) Appl. No.: 18/356,778

(22) Filed: Jul. 21, 2023

Related U.S. Application Data
(60) Provisional application No. 63/391,499, filed on Jul. 22, 2022.

(51) Int. Cl. B26B 21/52; A47K 7/02; B26B 21/22; A45D 34/04; A45D 27/00; A46B 5/00

(52) U.S. Cl. CPC B26B 21/521; A47K 7/028; B26B 21/523; B26B 21/225; A45D 34/041; A45D 34/042; A45D 27/00; A46B 5/0041; A46B 5/0095; A45D 2200/10; A45D 2200/25; A46B 2200/1006

(57) ABSTRACT

A body-care device of the present disclosure has an attachment means configured to attach to interchangeable attachment heads. The attachment means comprises a sliding rail. The attachment heads comprise a common or universally configured receiver with a channel. The sliding rail of the attachment means slides into the channel on the receiver to removably attach the interchangeable attachment head to the body-care device.

### CROSS-REFERENCE TO RELATED APPLICATIONS

This application claims the benefit of U.S. Provisional Patent Application Ser. No. 63/391,499 filed Jul. 22, 2022, the entirety of which is hereby incorporated herein by reference for all purposes. U.S. patent application Ser. No. 16/037,989 filed Jul. 27, 2018 (U.S. Pat. App. Pub. No. US 2019/010583 A1) is hereby incorporated by reference herein.

### TECHNICAL FIELD

The present invention relates generally to the field of a self-use body-care systems, and more particularly to a body care system with multiple interchangeable heads configured for detachable coupling with a handle assembly.

### BACKGROUND

Often, an individual may want to perform self-care actions on his/her back or other difficult to reach areas. Examples of these actions include scratching, exfoliating, massaging, applying lotion, shaving, and bathing/cleaning.

There are back scratcher devices, which include a long shaft and an implement on a far end. These devices can be used to reach places on the individual's back that cannot be reach with the individual's hands. However, these devices have limited capabilities.

It is to the provision of a self-use body-care systems meeting these and other needs that the present invention is primarily directed.

### SUMMARY

In example embodiments, the present invention provides a foldable self-use body-care systems having interchangeable attachment heads, as well as methods for attaching interchangeable attachment heads to a body-care device.

In one aspect, the present invention relates to a body-care system comprising a handle assembly having a first coupling element and a plurality of different interchangeable attachment heads, each of the plurality of different interchangeable attachment heads comprising a second coupling element configured for cooperative and detachable engagement with the first coupling element.

In another aspect, the invention relates to a body-care system, comprising a body-care device having an attachment means and an attachment head having a receiver. The attachment means comprises a slide rail, a first securing ridge, and a second securing ridge. The first securing ridge and the slide rail form a first groove, and the second securing ridge and the slide rail form a second groove. The attachment head comprises an implement and a receiver. The receiver further comprises a channel, a first edge having a first lip, and a second edge having a second lip. The receiver is configured to attach to the attachment means by inserting the slide rail into the channel of the receiver.

In still another aspect, the invention relates to a method of attaching an implement of a body-care device, the method comprising sliding an attachment head comprising an implement and a receiver with a channel onto a body-care device with an attachment means comprising a slide rail, such that the slide rail is inserted into the channel.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of a body-care system in the extended configuration according to an example embodiment of the present invention.

FIG. 2 is a perspective view of the body-care system of FIG. 1 in the folded configuration.

FIG. 3 is a front view of the body-care system of FIG. 1 in the folded position.

FIG. 4 is a side view of a handle assembly of the body-care system of FIG. 1.

FIG. 5 is a detailed profile or side view of a coupling portion of the handle assembly of FIG. 4.

FIG. 6 is a front view of a coupling portion of the handle assembly of FIG. 4.

FIG. 7 is a front view of a receiver of the body-care device of FIG. 1.

FIG. 8 is a profile or end view of the receiver of the body-care device of FIG. 1.

FIG. 9 is a side view of an invigorator brush attachment head according to an example embodiment of the present invention.

FIG. 10 is a profile or end view of the invigorator brush attachment head of FIG. 9.

FIG. 11 is a side view of a scrub brush attachment head according to an example embodiment of the present invention.

FIG. 12 is a profile or end view of the scrub brush attachment head of FIG. 11.

FIG. 13 is a side view of a massaging roller attachment head according to an example embodiment of the present invention.

FIG. 14 is a profile or end view of the massaging roller attachment of FIG. 13.

FIG. 15 is a side view of a lotion roller attachment head according to an example embodiment of the present invention.

FIG. 16 is a profile view of the lotion roller attachment head of FIG. 15.

FIG. 17 is a profile view of another embodiment of the body-care system.

FIG. 18 is a detailed front view of the body-care system of FIG. 17.

FIG. 19 is a detailed perspective view of the body-care system of FIG. 17.

FIG. 20 shows an exploded view of the body-care system of FIG. 17.

FIG. 21 shows multiple views of the body-care system of FIG. 17.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions, or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The detailed description describes an exemplary self-use body-care system in accordance with example embodiments of the present invention. The body-care system comprises a handle assembly with a coupling component on one end, and one or more attachment heads which can couple to the handle assembly. The attachment heads may be a brush, a loofa, a lotion roller, a massaging roller, a silicon scrubber, a razor, or another implement for body-care. The handle assembly has a first (upper) and second (lower) section, pivotally connected to each other by a hinge mechanism. In use, the body-care system may be expanded or left in the collapsed or folded configuration and used to scratch, rub, roll, or otherwise contact a user's body by grasping the handle and positioning the implement end of the back-invigorator device in proximity to the user's body. The body-care system may also be collapsed, for example, for transport, storage, or use.

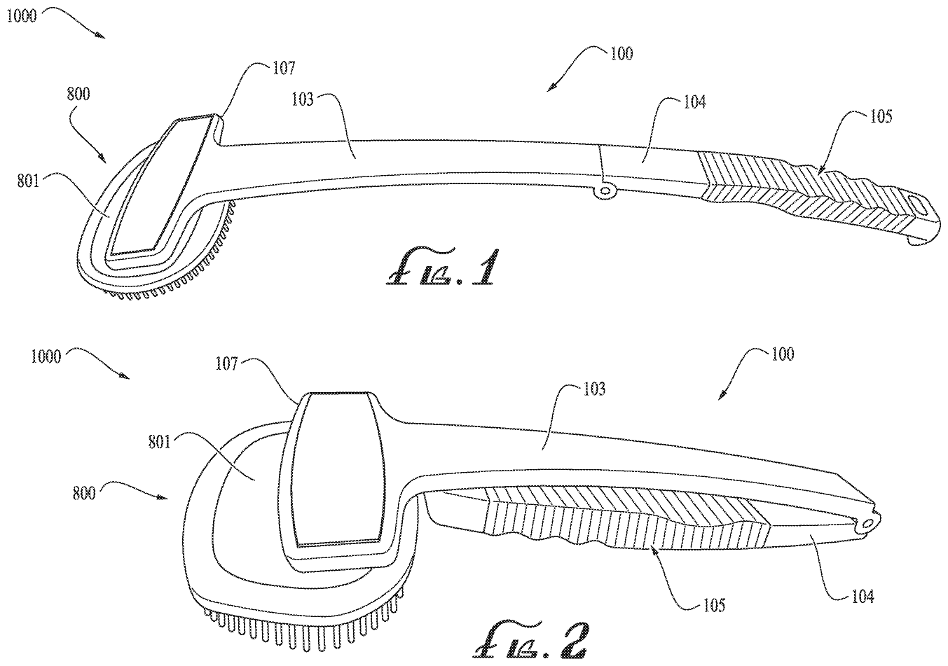

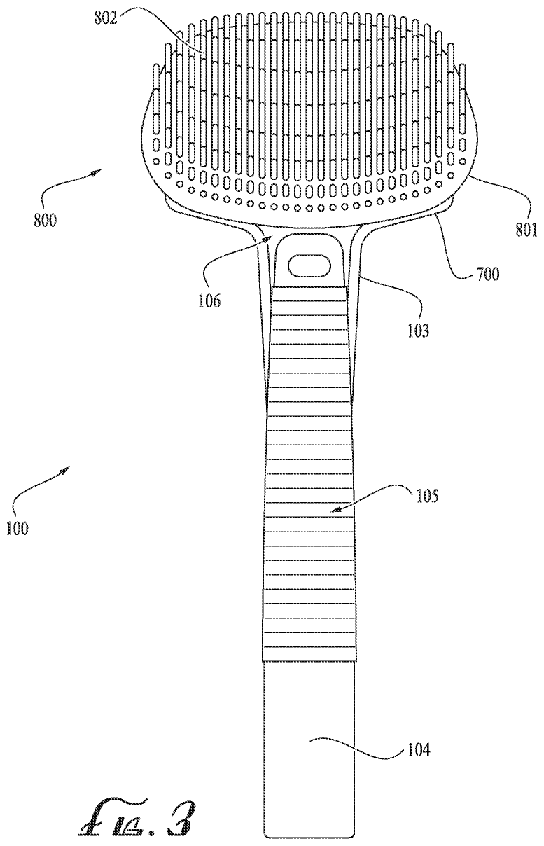

In example embodiments, such as the embodiment shown in FIGS. 1-3, the body-care system 1000 comprises a handle assembly 100 releasably coupled to an attachment head, such as silicone brush 800. The system 1000 may pivotably change between an extended configuration shown in FIG. 1, and a folded configuration shown in FIGS. 2 and 3.

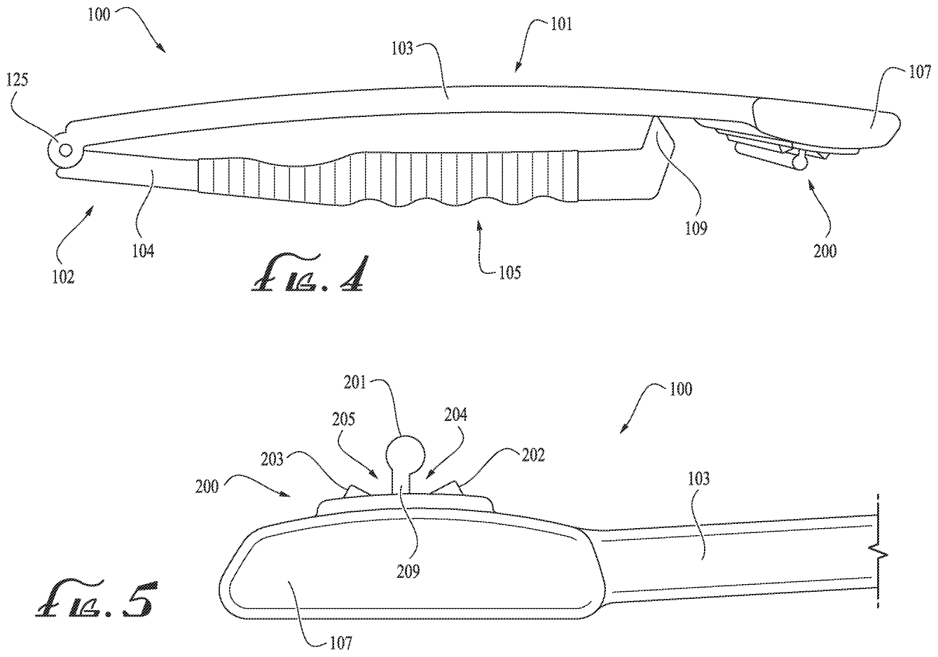

FIGS. 4-6 show the handle assembly 100 of the example body-care system 1000 without an attachment head. The handle assembly 100 comprises an upper section 101 and a lower section 102 hingedly or pivotally connected to one another by a hinge mechanism 125. In the present embodiment, the hinge mechanism 125 is a hinge. In other embodiments, the hinge mechanism 125 may be a hinge, a pivot joint, or any other suitable mechanism that allows the lower section 102 to pivot relative to the upper section 101 to reconfigure the handle assembly 100 between the folded and extended configurations.

The upper section 101 further comprises an upper shaft 103, a recess 106, and a coupling portion 107. The lower section 102 further comprises lower shaft 104, feet 109, and a handgrip portion 105 optionally comprising one or more ridges, recesses, or other grip-enhancing features. The recess 106 allows the feet 109 on the lower shaft 104 to contact the upper shaft 103 at a lower depth in the folded configuration, allowing lower section 102 to have a greater range of motion.

The upper and lower sections 101, 102 are configured to pivot relative to one another at the hinge mechanism 125, so that the system can transition between the folded or compact handle configuration and an unfolded or extended handle configuration. In the folded configuration, the uppers section 101 and the lower section 103 are positioned so that they are generally parallel to and alongside one another. In the expanded configuration the upper and lower sections 101, 102 extend generally coaxially, end-to-end, with one another.

The upper section 101 has a first length in an axial direction, extending between a distal or free first end, and a proximal or connected second end at the hinge. The lower section 102 similarly has a second length between a distal or free first end and a proximal or connected second end at the hinge mechanism 125. In the example embodiment shown in FIGS. 1-6, the first length of the upper section 101 is substantially greater or longer than the second length of the lower section 102, whereby in the folded configuration the free end of the lower section 102 of the handle terminates short of the free end of the upper section 101, preferably allowing the coupling portion 107 of the upper section 101 to extend beyond the free end of the lower section 102. In certain examples, the length of the upper section 101 is approximately equal to or just greater than (i.e., no more than about 1-2 inches greater than) the length of the lower handle segment 102 plus approximately 0.5-1 times the width of the attachment head measured along an axis substantially aligned with the handle assembly 101.

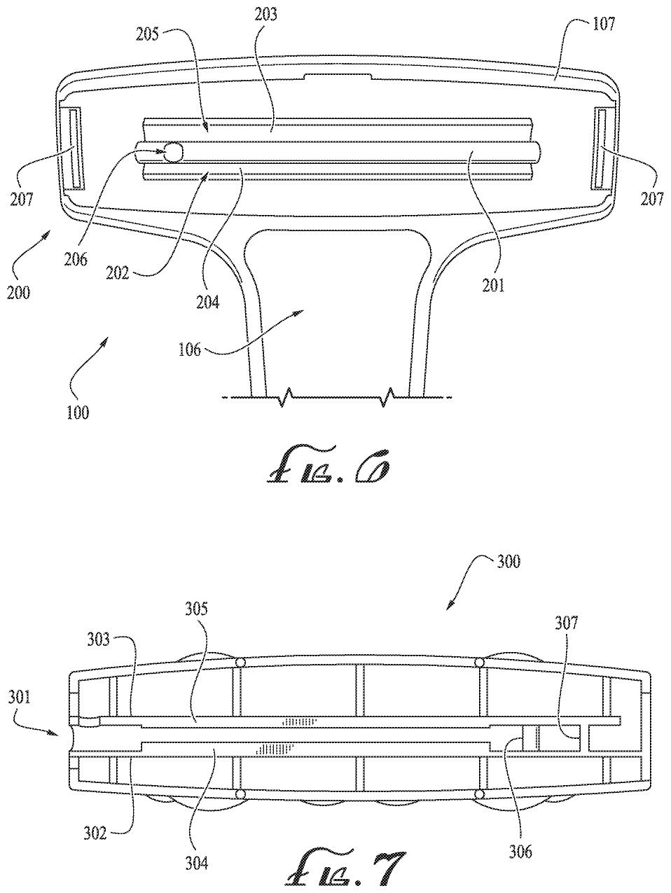

As best seen in FIGS. 5 and 6, the upper section 101 further comprise an attachment means 200, that allows a user to change between two or more interchangeable implements by sliding individual attachment heads on and off the attachment means 200. The attachment means 200 comprises a transversely extending slide rail 201 on a rail support 209. The slide rail 201 has a greater thickness towards its free end than the thickness of the rail support portion 209 to retain the interchangeable heads in connection with the handle when in use. The slide rail 201 is positioned between a first securing ridge 202 and a second securing ridge 203. The slide rail 201, the rail support 209, and the first securing ridge 202 form a first groove 204. Similarly, the slide rail 201, rail support 209, and the second securing ridge 203 form a second groove 205.

In example embodiments the first securing ridge 202, the second securing ridge 203, the first groove 204, and the second groove 205 may extend the width of slide rail 201. Optionally, the slide rail 201 may further comprise a third groove 206. In the embodiment shown, the attachment means 200 is removably connected to the coupling portion 107 of the upper section 101 using tabs 207. In other embodiments, the attachment means 200 may be integrally formed with the upper segment 101 of the handle assembly 100 or may be attached using adhesive, screws, or any other suitable attachment means.

The attachment means 200 is configured to allow detachable coupling of multiple different attachment heads (such as silicone brush 800), each of which has a cooperatively configured receiver portion 300, to couple attachment head to the handle assembly 100 of the device 1000 in am interchangeable fashion.

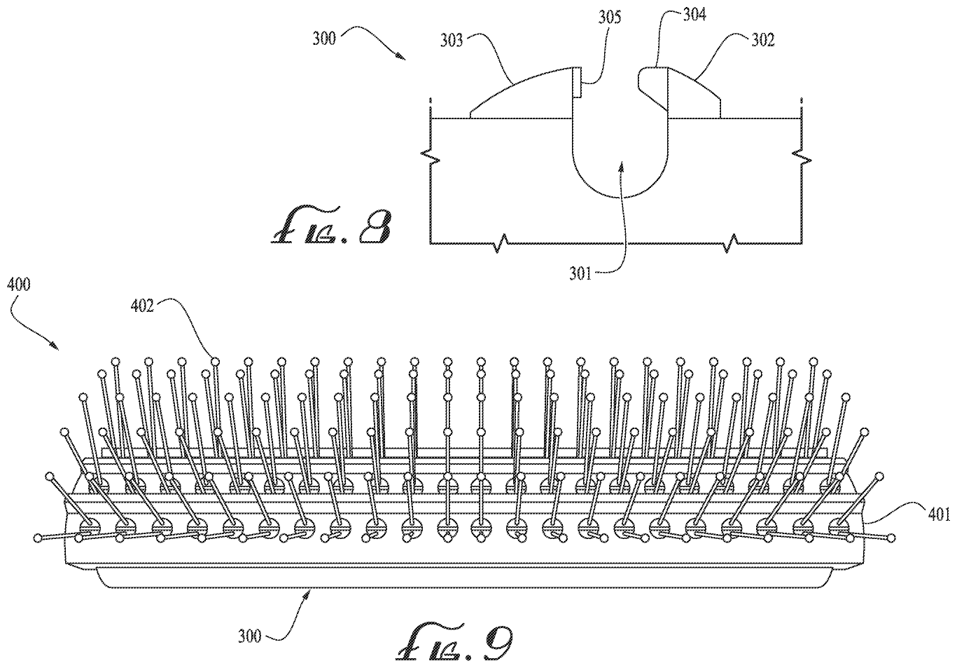

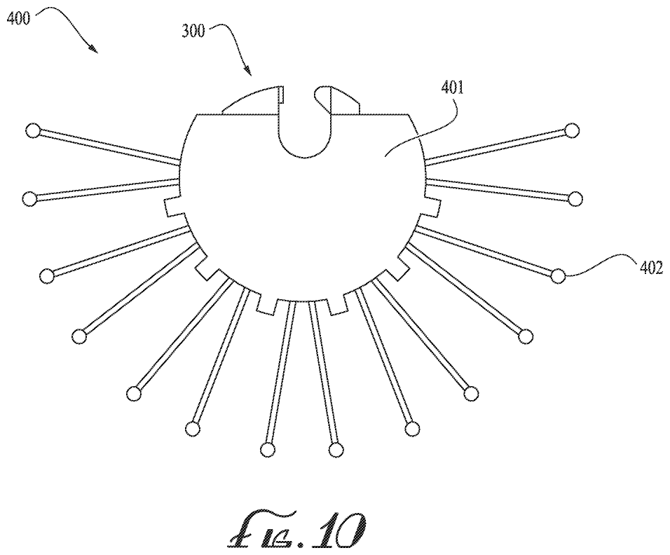

As seen in FIG. 7-8, in example embodiments, the receiver 300 may comprise a channel 301 formed in part by a first edge 302 and a second edge 303. In particular embodiments, first edge 302 and second edge 303 further comprise a first lip 304 and a second lip 305, respectively. Channel 301 optionally comprises a knob 306, a stop 307, or both. In the embodiment shown, first lip 304 and second lip 305 extend form first edge 302 and second edge 303 respectively to create an enclosure around channel 301. In such an embodiment, the channel 301 is configured to cooperatively receive the slide rail 201 of the handle assembly 100 to selectively and detachably couple each of the interchangeable heads, in turn, to the handle.

Referring generally now to the embodiment shown in FIGS. 1-8, to attach a user-selected interchangeable attachment head (such as silicone brush 800) with a receiver 300 to the attachment means 200, the slide rail 201 is inserted into the channel 301 on the receiver 300 of the attachment head. As the slide rail 201 is inserted into the channel 301 by sliding the head transversely or side-to-side onto the handle, the first lip 304 and the second lip 305 on the receiver 300 are inserted into the first groove 204 and the second groove 205 on the attachment means 200, respectively. The first lip 304 and the second lip 305 prevent out of axis motion of the receiver 300 relative to the slide rail 201 on attachment means 200 to prevent unintentional detachment of the head from the handle. Upon full insertion of slide rail 201 into the channel 301, the knob 306 within the channel 301 will be infixed within the third groove 206 on slide rail 201. The knob 306 within the third groove 206 serves to impede axial motion of the receiver 300 relative to the slide rail 201, thus releasably locking the receiver 300 into place onto the upper shaft 102 until significant axial force is applied. To remove an attachment head from the handle assembly 100, force is applied to the attachment head in a transverse direction (relative to the lengthwise axis of the handle) by the user in the direction of the axis of the slide rail 200.

In particular embodiments, knob 306 and third groove 206 are placed such that knob 306 becomes infixed within third groove 206 when the slide rail 201 is inserted into channel 301 from either direction. In other embodiments, a fixing means other than the knob 306 and third groove 206 is used. The fixing means may be the friction between slide rail 201 and channel 301, tabs, or any other suitable means to affix the receiver 300 relative to the attachment means 200 such that there is no movement in the axial direction.

In example embodiments, first securing ridge 202 and second securing ridge 203 are asymmetric relative to one another. Further, slide rail 201 extends asymmetrically from, and relative to, rail support 209. The combination of the asymmetric securing ridges 202, 203 and the asymmetric slide rail 201 placement results in a comparatively asymmetric first groove 204 and second groove 205. Likewise, the first lip 304 on receiver 300 and second lip 305 are asymmetric relative to one another. These asymmetries prevent insertion of the first lip 304 on receiver 300 into the second groove 205 on attachment means 200. As such, first lip 304 can only be inserted into first groove 204. Similarly, the shape of the channel 301 created by asymmetric first lip 304 and second lip 305 requires the slide rail 201 to be inserted into channel 301 in a particular orientation. Thus, each attachment head has only one possible coupling orientation relative to the handle assembly 100. As a result, when the receiver 300 has a stop 307, the attachment head can only slide onto slide rail 201 from one direction. This ensures that the knob 306 on receiver 300 does not infix within the third groove 206 before the slide rail 200 is fully inserted into channel 301.

In alternate embodiments, the first securing ridge 202 and the second securing ridge 203 may be symmetric. The slide rail 201 may also be symmetric about rail support 209. In particular embodiments, the first groove 204 and the second groove 205 may be the same shape and size. Likewise, the first lip 304 and the second lip 305 may be the same shape and size such that the channel 301 is substantially symmetric. In such embodiments, the attachment heads may have multiple coupling orientations relative to the handle assembly 100.

In example embodiments of the body-care system 1000, the handle assembly 100 is configured to connect or couple to any number of interchangeable attachment heads. In the example embodiment shown in FIGS. 1-3, the handle assembly 100 is coupled to silicone brush 800. The attachment head, silicon brush 800, comprises a base 801 incorporating receiver 300 configured for cooperative compatible engagement with the attachment means 200 of the handle assembly 100. The silicon brush 800 further comprises a plurality of silicone bristles 802 extending from the base 801. The silicone brush 800 has a shape that provides optimal body cleaning coverage. Its bristles 802 are soft to the touch, yet firm enough to effectively clean the body. The silicon brush 800 may also be removed from the handle assembly 100 and used on its own.

In the embodiment shown in FIGS. 1-3, the lower shaft 104 of the handle assembly 100 is shorter in length than the upper shaft 103 (including the attachment head). As such, the lower shaft does not cover the attachment head, silicone brush 800, when the device 110 is in the shorter-handle folded configuration. Therefore, the device 100 can be gripped and used in the closed/folded position, and the attachment 800 can be accessed or changed with the handle assembly 100 in this position.

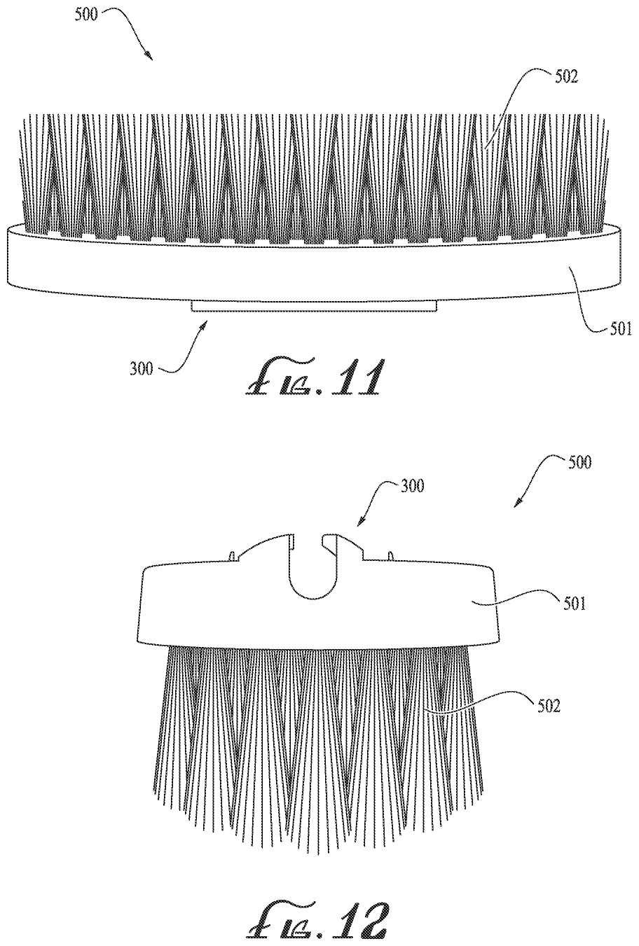

In example embodiments, the handle assembly 100 of the body-care system 1000 is configured to connect to any number of interchangeable attachment heads. An example attachment head, invigorator brush attachment 400, is shown in FIGS. 9 and 10. The invigorator brush attachment 400 comprises an attachment body 401 incorporating a receiver 300 configured for cooperative compatible engagement with the attachment means 200 of the handle assembly 101. The invigorator brush 400 further comprises a plurality of individual bristles or fingers 402 extending from the semi-cylindrical central attachment body 401, arranged in parallel rows and extending generally radially from a center line running the width of the attachment head 400. Each bristle or finger optionally comprises a rounded expanded head at its tip for user comfort.

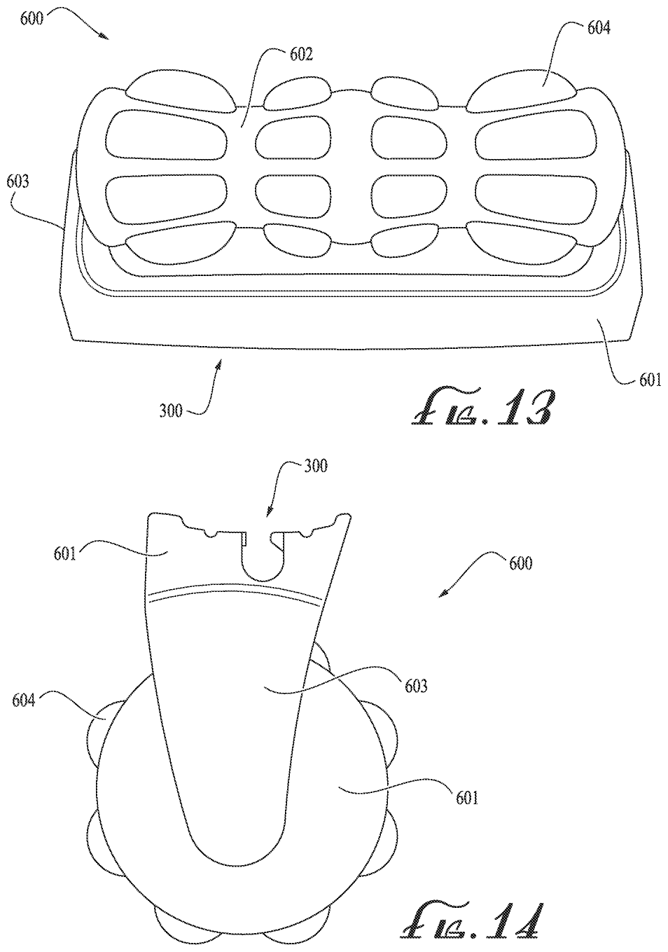

FIGS. 11 and 12 show another example embodiment of an interchangeable attachment head, scrub brush attachment 500. The brush attachment 500 comprises a base 501 incorporating a receiver 300 configured for cooperative compatible engagement with the attachment means 200 of the handle assembly 100. The scrub brush attachment 500 further comprises a plurality of bristles 502 that extend from the base 501.

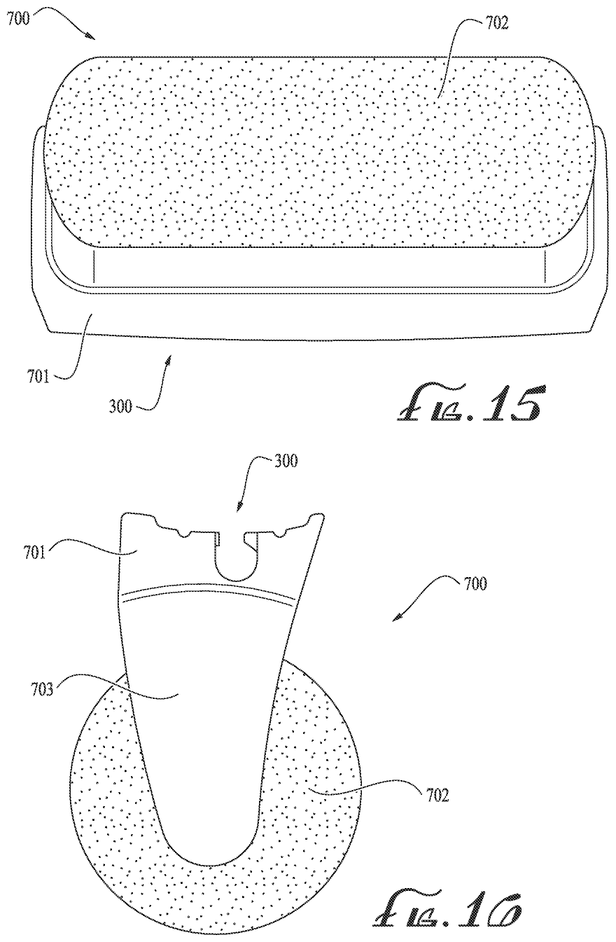

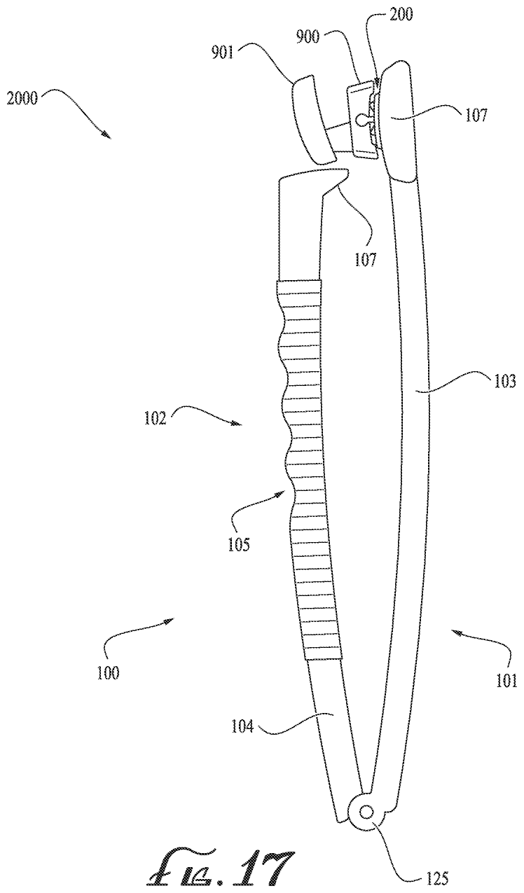

FIGS. 13 and 14 show another example embodiment of an interchangeable attachment head, massaging roller 600. The massaging roller attachment 600 comprises a base 601 incorporating a receiver 300 configured for cooperative compatible engagement with the attachment means 200 of the handle assembly 100. The base panel 601 further comprises support arms 603 extending from each end, to which a roller 602 is rotationally mounted. The mounting allows the roller 602 to rotate as the massaging roller 600 is moved across a surface. The massaging roller attachment 600 optionally includes an array of nubs or projections 604 extending outwardly from the roller 602.

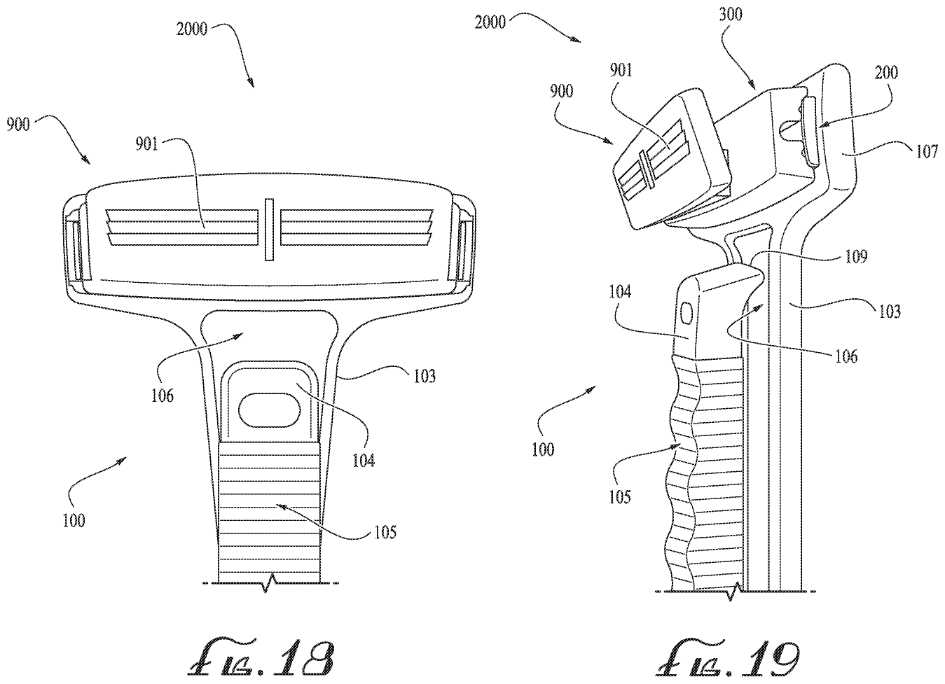

FIGS. 15 and 16 show another example embodiment of an interchangeable attachment head, lotion roller attachment 700. Lotion roller attachment 700 comprises a base 701 incorporating a receiver 300 configured for cooperative compatible engagement with the attachment means 200 of the handle assembly. The lotion roller attachment 700 further comprises a substantially cylindrical roller 702, for example, in the form of a foam roller about the width of the attachment head 700. The base panel 701 further comprises support arms 703 extending from each end, to which the roller 702 is rotationally mounted. The mounting allows the roller 702 to rotate as the lotion roller 700 is moved across a body surface,

In example embodiments, a system may be provided with a plurality (two, three, four, five, or more) of interchangeable attachment heads configured for detachable coupling with the universal handle assembly 100. In use, a user selects a desired one of the interchangeable attachment heads and couples that attachment head to the handle assembly 101 by engagement of attachment head receiver 300 with the attachment means 200 of the handle assembly 101. The handle assembly may be unfolded to its elongate configuration to allow greater reach, for example to allow a user to reach the attachment head into contact with their back for scratching an itch, invigorating the skin, applying lotion, or other intended purposes. As the upper section 101 of the handle assembly 100 has a greater length than the lower section 102, the handle assembly 101 may also be used in the folded configuration when a shorter, more compact device is desired, for example, when using the device in confined spaces, such as showers, or on certain body parts, such as the chest. After use of the first selected interchangeable attachment head, the user may exchange one attachment head for another by removing the previously used attachment head from the handle assembly, and thereafter install a different attachment head for subsequent use. Such an exchange may be conde while the system is in the folded or unfolded configuration.

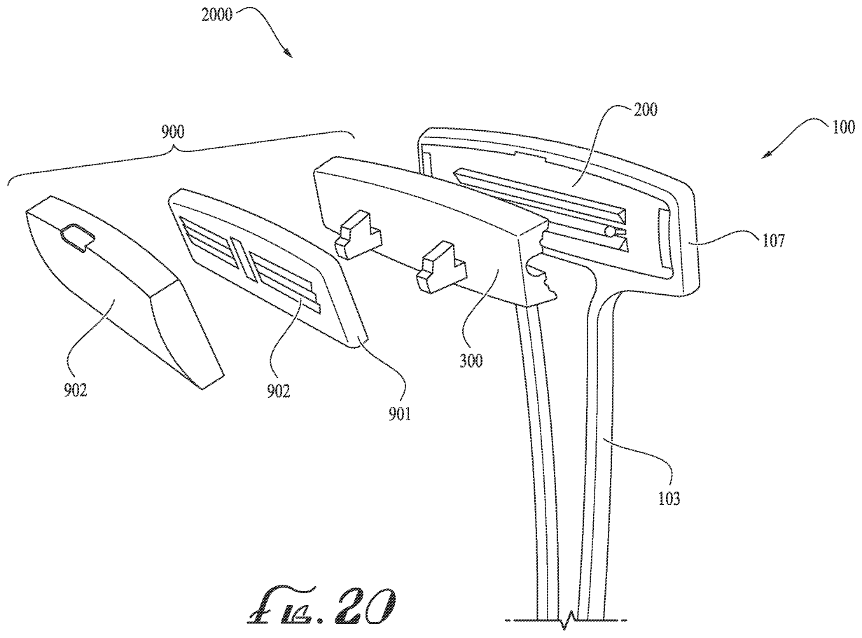

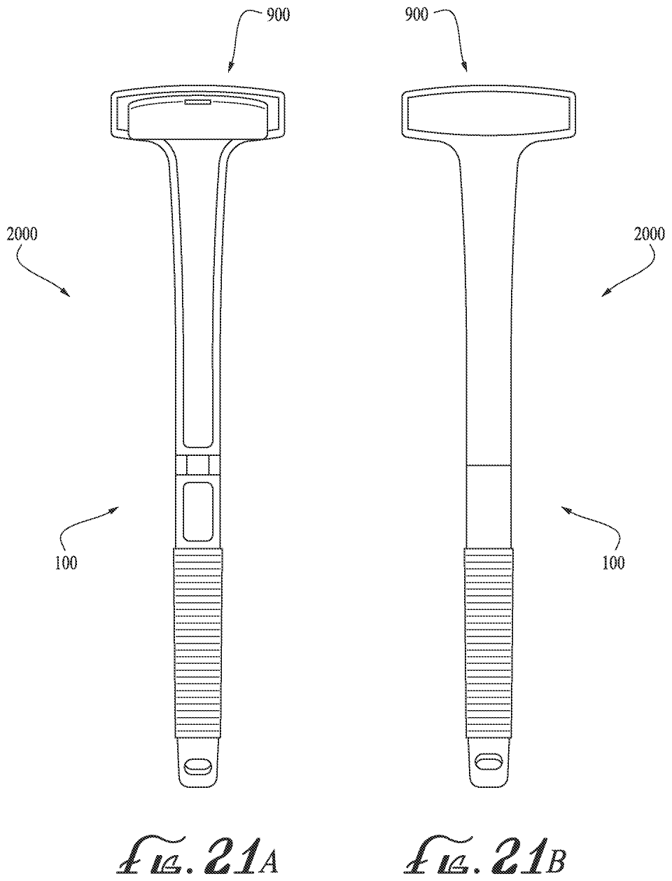

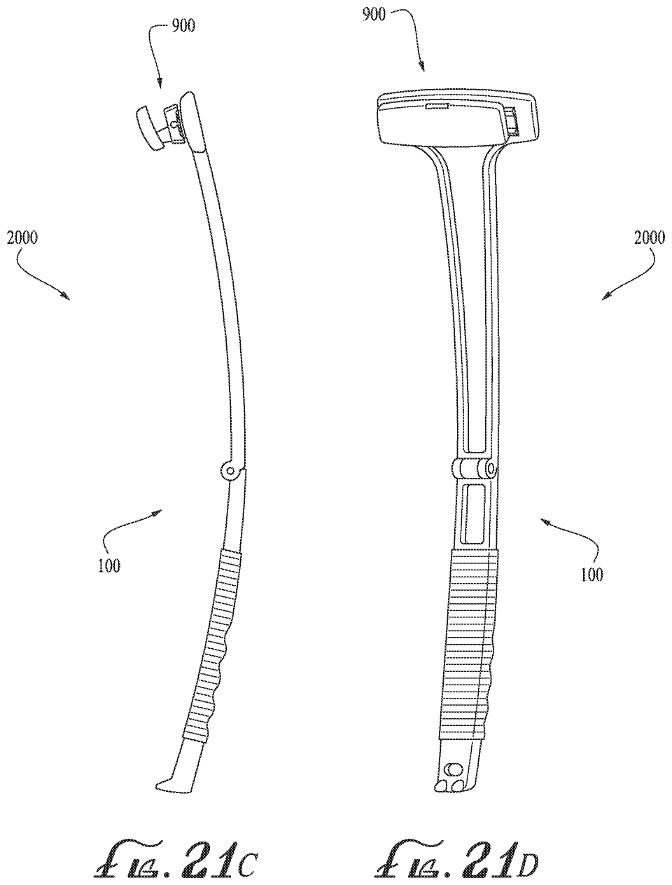

FIGS. 17-21 show another example embodiment of a body-care system 2000 comprising the handle assembly 100 and an attachment head, razor attachment 900. The razor attachment 900 comprises a razor blade assembly 901 pivotally connected to a receiver 300 configured for cooperative compatible engagement with the attachment means 200. The razor blade assembly 901 comprises multiple razor blades 902 attached at an angle to the rest of the assembly 901. The razor assembly 901 may pivot about an attachment point, allowing for easier and more comfortable use. The razor assembly 901 is designed for wet or dry use. The razor assembly 901 may be removably attached to the receiver 300, so that the razor assembly 901 can be changed without replacing or removing the receiver 300. The razor attachment 900 may optionally comprise a protective cover 904 that attaches to a razor implement 901.

As previously stated, the body-care system 2000 can be used in the closed/folded shorter-handle configuration or the extended longer-handle configuration. In the folded configuration, the lower shaft 104 is pivoted about the hinge mechanism 125, until the lower shaft 104 is in substantial alignment with the upper shaft 103. The lower shaft 104, however, does not cover a user's chosen attachment head, such as razor attachment 900. This configuration shortens the apparent length of the body-care device 100. The shorter length may allow the user to use the device in confined spaces, such as showers, or on certain body parts, such as the chest. For example, the user may wish to use the silicon scrubber 800 or another attachment in a shower where room/space may be limited, or when the user desires to be able to assert more force on the device. The user may also wish to use the folded configuration when using the razor attachment 900 to shave their chest, as a longer handle may decrease the amount of control a user has over the device.

In the closed/folded position, the handle 105 may still be accessed by the user, allowing for additional grip when compared to the user simply holding the device by the upper shaft when the device is in the extended configuration. The bowing of the upper and lower segments 101, 102 also allows for a wider grip when the device is used in the folded configuration, which may allow for more control over the device.

In some embodiments, the free end of the lower shaft 104 may releasably attach to the free end of the upper shaft 105 below the attachment head. In some embodiments, this is achieved through adding to or replacing the feet 109 with a coupling mechanism, such as the male end of a snap connector, which is configured to releasably engage with a receiving mechanism, such as the female end of a snap connector, within the recess 106. This may allow the distal or free first end of the upper segment 101 to releasably engage the distal or free first end of the lower segment 102 to retain the device in the folded position during use. In other embodiments, the coupling and receiving mechanisms may be switched. Other suitable attachment mechanisms may also be used.

While the invention has been described with reference to example embodiments, it will be understood by those skilled in the art that a variety of modifications, additions and deletions are within the scope of the invention, as defined by the following claims.

What is claimed is:

1. A body-care system comprising:
a handle assembly having a first coupling element; and
a plurality of different interchangeable attachment heads, each of the plurality of different interchangeable attachment heads comprising a second coupling element configured for cooperative and detachable engagement with the first coupling element.

2. The body-care system of claim 1, wherein the handle assembly comprises a first handle portion, a second handle portion, and a hinged coupling pivotally connecting the first and second handle portions and allowing relative movement of the handle assembly between a folded configuration and an extended configuration.

3. The body-care system of claim 2, wherein the first handle portion comprises a coupling panel incorporating the first coupling element, and wherein the first handle portion has a substantially greater length than the second handle portion, whereby the coupling panel of the first handle portion extends beyond a free end of the second handle portion opposite the hinged coupling in the folded configuration.

4. The body-care system of claim 1, wherein the plurality of different interchangeable attachment heads comprise at least one brush-format attachment head and at least one roller-format attachment head.

5. The body-care system of claim 4, wherein the at least one brush-format attachment head comprises a central core with a plurality of bristles extending from the central core and wherein the plurality of bristles are arranged in a generally radial array comprising a plurality of rows of bristles each extending generally radially from a transverse axis of the central core.

6. The body-care system of claim 1, wherein the coupling element comprises a slide rail.

7. The body-care system of claim 1, wherein the interchangeable attachment heads comprise one or more of a brush, a roller, or a razor blade assembly.

8. The body-care system of claim 1, wherein one of the interchangeable attachment heads comprises a razor, the razor further comprising a razor blade assembly having one or more razor blades, and a base housing the second coupling element, wherein the razor blade assembly is releasably and pivotally attached to the base such that the razor blade assembly may be attached or removed from the base without decoupling the base from the handle assembly.

9. A body-care system, comprising
a body-care device comprising an attachment head, the attachment head further comprising:
a slide rail;
a first securing ridge; and
a second securing ridge, wherein the first securing ridge and the slide rail form a first groove and the second securing ridge and the slide rail form a second groove; and
an attachment head, the attachment head further comprising:
an implement; and
a receiver, the receiver further comprising;
a channel,
a first edge having a first lip; and
a second edge having a second lip;
wherein the receiver is configured to attach to the attachment means by inserting the slide rail into the channel.

10. The body-care system of claim 9, wherein the first securing ridge and the second securing ridge are different sizes.

11. The body-care system of claim 9, wherein the slide rail has an asymmetric shape.

12. The body-care system of claim 9, wherein the first groove has a first shape, and the second groove has a second shape.

13. The body-care system of claim 9, wherein the slide rail further comprises a third groove.

14. The body-care system of claim 9, wherein the receiver further comprises a stop.

15. The body-care system of claim 9, wherein the receiver further comprises a know within the channel.

16. The body-care system of claim 9, wherein the first lip and the second lip are of different dimensions.

17. The body-care system of claim 9, wherein the first edge and second edge are of different dimensions.

18. A method of attaching an implement of a body-care device, the method comprising sliding an attachment head comprising an implement and a receiver with a channel onto a body-care device with an attachment means comprising a slide rail, such that the slide rail is inserted into the channel.

19. The method of claim 18, wherein the body-care-device comprises a handle assembly comprising a first handle portion, a second handle portion, and a hinged coupling pivotally connecting the first and second handle portions and allowing relative movement of the handle assembly between a folded configuration and an extended configuration.
